(19) United States
(12) Patent Application Publication
(10) Pub. No.: US 2006/0262537 A1
(43) Pub. Date: Nov. 23, 2006

(54) Projection assembly

(76) Inventors: John W. Lee, Sweet Home, OR (US); Jimmy Perez, Corvallis, OR (US); Kenneth Corcoran, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/131,656

(22) Filed: May 17, 2005

(51) Int. Cl. F21V 7/00

(52) U.S. Cl. 362/296

(57) ABSTRACT

A projection assembly includes a reflector; a burner coupled to the reflector; and a fan. The fan is configured to simultaneously cool the burner and the reflector by directing a substantial portion of the airflow over the reflector and a burner cooling portion of the airflow substantially parallel to a long dimension of the burner.

### BACKGROUND

Digital projectors, such as digital micro-mirror devices (DMD) and liquid crystal devices (LCD) projectors, project high quality images onto a viewing surface. Both DMD and LCD projectors utilize high intensity burners and reflectors to generate the light needed for projection. Light generated by the burner is concentrated as a “fireball” that is located at a focal point of a reflector. Light produced by the fireball is directed from the reflector into a projection assembly that produces images and utilizes the generated light to illuminate the image.

Efforts have been directed at making projectors more compact while making the image of higher and better quality. As a result, the burners utilized have become more compact and of higher intensity. Higher intensity burners produce high, even extreme heat. For example, the proper operating temperature of the burners is frequently between temperatures of about 850 to 950 degrees Celsius. If the burner is allowed to deviate from this range, the burner may not operate properly. For example, if the burner is below the operating temperature range, the burner may not fire. Further, if the burner is above the operating temperature range, the burner may fail.

While the burner is operating, some of the heat generated by the burner frequently accumulates in the reflector. A portion of the heat from the reflector may then be transferred to the surrounding environments. Some designs attempt to reduce the build-up of heat in the reflector and to maintain the burner within its operating temperature range by using one or more fans directed to the reflector and one or more separate fans directed to the burners.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic of a display system according to an example embodiment.

FIG. 2 illustrates an exploded perspective view of a lamp assembly according to an example embodiment.

FIG. 3 illustrates an end view of a reflector according to an example embodiment.

FIG. 4 illustrates a sectional view of the exemplary lamp assembly shown in FIG. 2 taken with respect to line B-B.

FIG. 5 illustrates a sectional view of the exemplary lamp assembly show in FIG. 2 taken with respect to the line C-C.

FIG. 6 illustrates a flow diagram of airflow directed to the lamp assembly according to an example embodiment.

FIG. 7 illustrates a method of forming a projection assembly according to an example embodiment.

FIG. 8 illustrates a method of cooling a projection assembly according to an example embodiment.

Throughout the drawings, identical reference numbers designate similar, but not necessarily identical, elements.

### DETAILED DESCRIPTION

An assembly and method are provided herein for use in display systems that make use of a lamp assembly. In particular, an exemplary assembly and method discussed below make use of a single fan to simultaneously provide cooling for an entire lamp assembly, including simultaneously cooling a reflector and a burner. According to one exemplary embodiment, the fan directs airflow to the lamp assembly. A substantial portion of the airflow is passed over the outer portion of the reflector. Another lesser portion of the airflow passes through spaces between the burner assembly and the reflector and is passed parallel to the long dimension of the burner, thereby cooling the lamp assembly. The amount of heat removed, or the cooling rate, may be controlled by varying several factors, including the volumetric flow rate of the airflow directed to the burner. Such configurations may reduce the noise and space associated with cooling a lamp assembly.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

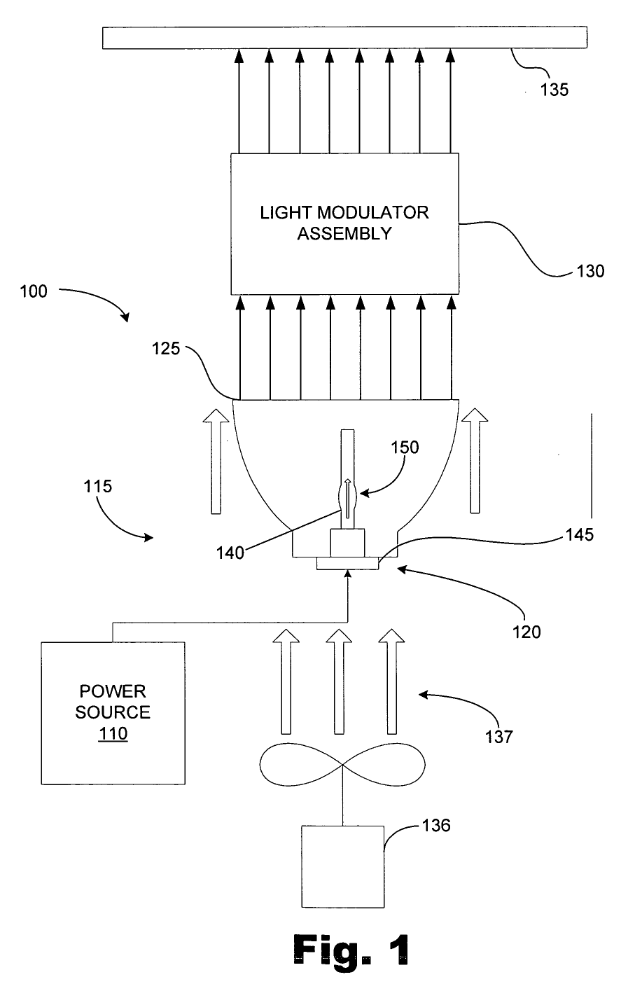

FIG. 1 is a schematic view of a display system (100). The display system (100) generally includes a power source (110), a lamp assembly (115) having a burner assembly (120) and a reflector (125), a light modulator assembly (130), and a viewing surface (135). A single fan (136) cools the burner assembly (120) and the reflector (125), as will be discussed in more detail below. In particular, a substantial portion of airflow (137) from the fan (136) is directed to the reflector (125), while a lesser portion (138) of airflow (137) from the fan (136) is directed through a gap between the reflector (125) and the burner assembly (120). In particular, the lesser portion (138) of airflow (137) passes substantially along the length of the burner assembly, or parallel to the long dimension of the burner assembly (130).

According to the present exemplary embodiment, the burner assembly (120) is removably coupled to the reflector (125). Those of skill in the art will appreciate that the airflow (137) may also be directed through any gaps which allow air from the fan (136) to cool the burner assembly (120), including, without limitation, gaps established between a burner assembly (120) that is permanently coupled to the reflector (125) and/or holes defined in the reflector (125). For ease of reference, a burner assembly (120) will be discussed herein that is removably coupled to the reflector (125). However, in some embodiments, the burner assembly (120) may be fixedly coupled to the reflector (125).

The burner assembly (120) is aligned and oriented relative to the reflector (125). In particular, the burner assembly (120) includes a burner (140) coupled to a header (145). The header (145) provides support and alignment for the burner (140) relative to the reflector (125). According to the present exemplary embodiment, the header (145) also allows the burner assembly (120) to be removably coupled to the reflector (125). As a result, when the burner (140) has surpassed its useful life, the burner assembly (120) may be replaced without replacing the entire lamp assembly (115).

The reflector (125) is configured to receive the burner assembly (120). In particular, the reflector (125) is configured to have the header (145) placed into aligned contact therewith. The alignment of the burner (140) relative to the header (145) may be known such that aligned contact between the header (145) and the reflector (125) constrains the position and orientation of the burner (140) relative to the reflector (125).

The alignment of the burner (140) relative to the header (145) and the alignment of the header (145) relative to the reflector (125) provides for alignment of the burner (140) relative to the reflector (125). More specifically, according to one exemplary embodiment, the burner (140) generates concentrated light, referred to as a fireball, in a central portion (150) thereof. By aligning the fireball with the focal point of the reflector (125), the amount of light generated by the lamp assembly (115) may be optimized.

The reflector (125) and/or header (145) may include datum structures thereon for alignment between the reflector (125) and the header (145). According to one exemplary embodiment, the header (145) includes a generally planar surface that is configured to be placed into contact with several datum surfaces on the reflector (125). Some of these datum surfaces may include a plurality of protrusions for limiting the insertion of the burner assembly (120) relative to the reflector (125). When the header (145) is in contact with these protrusions, a gap is defined between the header (145) and the gap between each of the protrusions. This gap may allow air to flow over the burner assembly (120) and over the burner in particular, as will now be discussed in more detail below.

Lamp Assembly

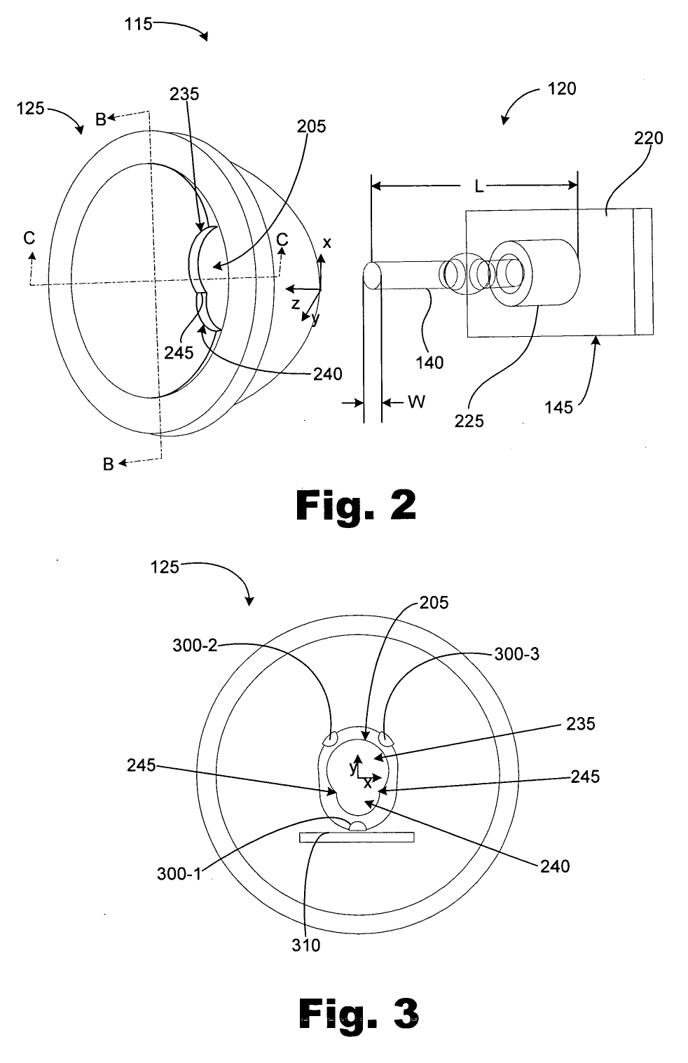

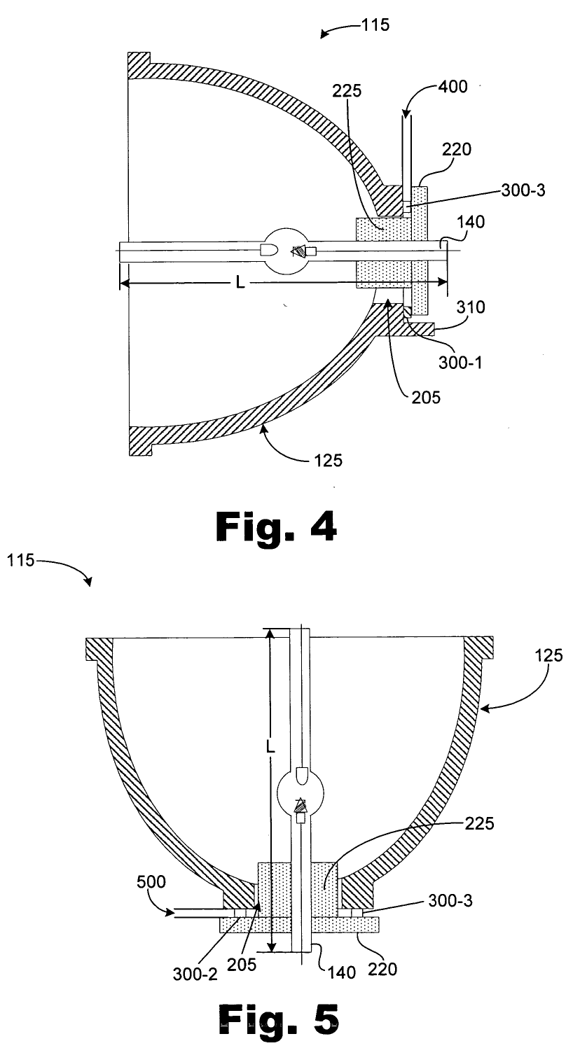

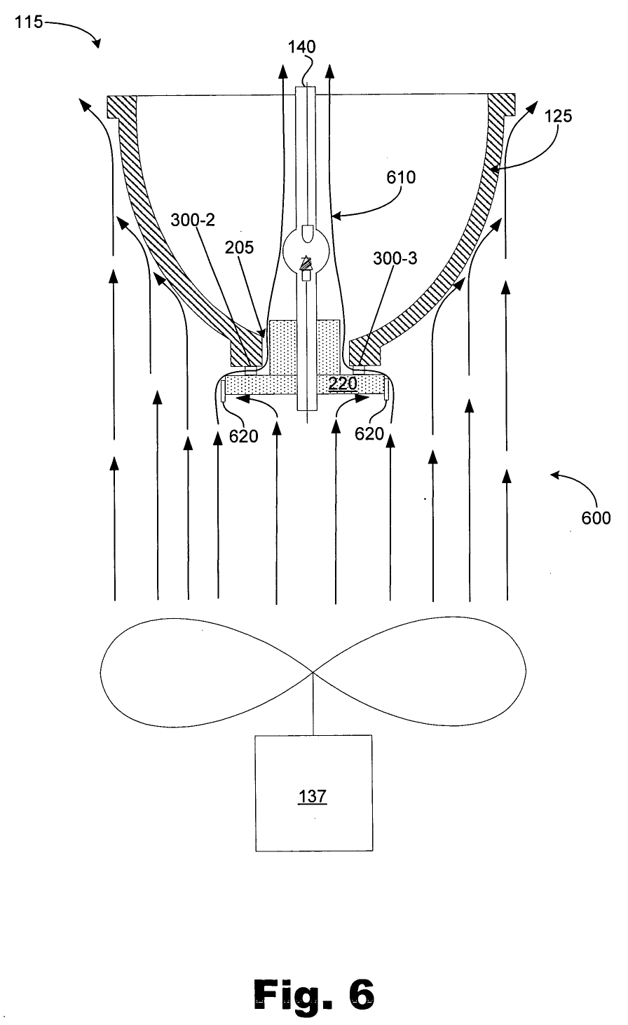

FIGS. 2 through 6 illustrate more detail views of the lamp assembly (115) according to one exemplary embodiment in more detail. In particular, FIG. 2 illustrates a perspective view of the lamp assembly (115), in which the burner assembly (120) is removed from the reflector (125). FIG. 3 illustrates a rear view of the reflector. FIG. 4 illustrates a cross sectional view of the reflector (125) taken along section B-B. FIG. 5 illustrates a cross sectional view of the reflector taken along section C-C. FIG. 6 illustrates airflow directed to the lamp assembly (115). For ease of reference, alignment of the burner assembly (120) with respect to the reflector (125) references an X, Y, and Z coordinate system having its origin at the outside edge of the reflector opening (105), as shown in the figures.

FIG. 2 illustrates an exploded view of the lamp assembly (115) that generally includes a reflector (125) and a burner assembly (120). The burner (140) may be of any suitable type that produces sufficient light, such as for projection and/or television applications. An example of a burner is an ultra-high pressure mercury arc burner. The burner (140) includes a length (L) and a width (W). The header (145) allows the burner (140) to be coupled to the reflector (125).

The header (145) includes a base member (220), and a burner engaging member (225) extending away from the base member (220). The burner engaging member (225) shown is a cylindrical burner engaging member (225).

The reflector (125) may be of any suitable type, including a parabolic or elliptical reflector. In addition, the reflector (125) may be configured to be utilized in a number of systems, including projection or television applications. In addition, the reflector (125) may be formed of a metallic material such as zinc, aluminum, magnesium, brass, copper, alloys thereof or other suitable materials. Such a configuration may allow the reflector (125) to also serve as a heat sink for reducing heat buildup in a lamp assembly.

The reflector (125) has a reflector opening (205) defined therein. The reflector opening (205) is of sufficient size to allow at least part of a burner to be passed therethrough and to allow air to flow substantially parallel to the length (L) of the burner (140). The interaction of the burner engaging member (225) with an exemplary reflector opening (205) will now be discussed in more detail.

According to one exemplary embodiment, the reflector opening (205) includes cylindrical voids (235, 240). A ridge (245) is formed at each of the intersections of the cylindrical voids (235, 240). The configuration of the reflector opening (205), including the cylindrical voids (235, 240) supports the burner assembly (120) while allowing air to flow around the burner assembly (120) and into the reflector (125).

Limiting the contact between the burner engaging member (225) and the reflector opening (205) to contact along the ridges (245) constrains the location of the burner assembly (120) in the X-Y plane shown in FIG. 2. More specifically, the ridges (245) extend through the thickness of the reflector (125). As the ridges (245) extend through the thickness of the reflector (125), the ridges (245) define substantially parallel lines. A single plane is defined by a line and a point outside that line. As introduced, each ride (245) defines a line. Accordingly, a single plane is defined between one ridge and a point on the other ridge. As introduced, the ridges (245) according to the present exemplary embodiment are substantially parallel Accordingly, a single plane passing through one ridge and a point on the other ridge will substantially pass through the rest of the other ride. Thus, limiting contact between the burner engaging member (225) along the ridges (245) constrains the location of the burner assembly (120) in a single plane.

With respect to the chosen coordinate system, the alignment plane is substantially parallel to the Y-Z plane. As a result, placing the burner engaging member (225) in simultaneous contact with the ridges (245) constrains the translation and rotation of the burner assembly (120) with respect to the X-axis and the Y-axis while providing a pathway for air to flow between the burner engaging member (225) and the reflector opening (205). One or more gaps may be provided between a datum structure on the reflector (125) and the base member (220), as will be discussed in more detail below.

FIG. 3 illustrates a rear view of the reflector (125) of FIG. 2. In the exemplary reflector shown (125), first, second and third Z-axis alignment protrusions (300-1, 300-2, 300-3) and a Z-axis anti-rotation surface (310) are shown formed near the reflector opening (205). Such alignment protrusions allow for the aligned coupling of the burner assembly (120) to the reflector (125).

A single plane is defined by the Z-axis alignment protrusions (300-1, 300-2, 300-3). Accordingly, placing the base member (220; FIG. 2) in contact with the Z-axis alignment protrusions (300-1, 300-2, 300-3) further constrains the orientation of the header (145; FIG. 2) in the plane defined by the Z-axis alignment protrusions (300-1, 300-2, 300-3). Consequently, this contact constrains the translation of the header (145; FIG. 2) parallel to the Z axis.

The exemplary reflector (125) shown includes a Z-axis anti-rotation surface (310). The Z-axis anti-rotation surface (310) is configured to have the bottom surface of the base member (220) placed in contact therewith. As previously discussed, if the burner engaging member (225) is in contact with ridges (245) and the base member (220) is placed in contact with the Z-axis alignment protrusions (300-1, 300-2, 300-3), five of the six degrees of freedom of the alignment and orientation of the burner assembly (120) with respect to the reflector (125) are constrained.

Placing the base member (220) in contact with the Z-axis anti-rotation surface (310) constrains the rotation of the burner assembly (120) about the Z axis. In particular, the Z-axis anti-rotation surface (310) is substantially planar and its orientation and location are substantially fixed relative to the reflector (125). The bottom surface of the base member (220) may also substantially planar. Consequently, placing these two surfaces in contact with each other causes the surfaces to be substantially coplanar. Because the orientation and alignment of the Z-axis anti-rotation surface (310) is fixed, the contact between the two surfaces constrains the rotation of the burner assembly (120) about the Z axis.

As seen in FIGS. 4 and 5, the resulting lamp assembly (115) has a plurality of gaps between the base member (220) and the Z-axis alignment protrusions (300-1, 300-2, 300-3). In particular, FIG. 4 is a cross sectional view of the lamp assembly (115) taken along section B-B. FIG. 5 illustrates a cross sectional view of the lamp assembly (215) taken along section C-C.

FIG. 4 illustrates one of the gaps (400) between two of the Z-axis alignment protrusions (300-1, 300-3). More specifically, the first and third Z-axis alignment protrusions (300-1, 300-3) contact the base member (220) at a spaced distance from the reflector opening (205). The resulting space creates the gap (400) that is approximately equal to the distance between the Z-axis alignment protrusions (300-1, 300-3) multiplied by the thickness of the Z-axis alignment protrusions (300-1, 300-3), which may be of substantially the same thickness. According to the present exemplary embodiment, a similar gap exists between the first and second Z-axis alignment protrusions (300-1, 300-3).

Further, as seen in FIG. 5, a similar gap (500) exists between the first and second Z-axis alignment protrusions (300-2, 300-3). As will be discussed in more detail below, the size of these gaps (400; FIG. 4, 500) may be varied to control airflow, and hence, the cooling of the burner (140).

Airflow from a Single Fan Over an Exemplary Lamp Assembly

FIG. 6 illustrates airflow over the lamp assembly (115) from a single fan (136). As seen in FIG. 6, a substantial portion of an airflow (600) produced by the fan (136) is directed to the reflector (125). As will be discussed in more detail below, the fan (136) produces an airflow (600) that is used to cool both the reflector (125) and the burner (140) by causing a portion of the airflow (600) to flow substantially parallel to the length (L) of the burner (140). Such a configuration may reduce the noise and space associated with separate fans for cooling the burner and the reflector.

In general, the amount of heat removed from an object by a flowing fluid depends upon several factors. Some of these factors include the volumetric flow rate, the temperature, and the heat transfer properties of the fluid used to cool the object. For ease of reference, room temperature air will be used to describe the fluid used to cool the lamp assembly (115), though other fluids and/or other temperatures may be used. Thus, the cooling effects of room temperature air depend, at least in part, on the volumetric flow rate of the air. The volumetric flow rate depends on the area through which the air flows and the speed of the air.

As previously discussed, a substantial portion of the airflow (600) is directed to the reflector (125) while another portion, or a burner cooling airflow (610), passes through the gaps discussed above and is directed along the length (L) of the burner (140). Further, in addition to flowing parallel to the length (L) of the burner (140), the portions of the burner cooling airflow (610) surround a substantial portion of the perimeter of the burner (140) along the length (L) of the burner (140). As a result, all sides of the burner (140) may be simultaneously cooled, thereby providing uniform cooling of the burner (140). Providing uniform cooling may decrease hot spots on the burner, thereby helping ensure the burner remains at an appropriate operating temperature.

The area through which the air flows to the burner (140) may be the area defined by gaps between the Z-axis alignment protrusions (300-1, 300-2, 300-3; FIG. 3) and the base member (220), as discussed above. As seen in FIG. 6, the burner cooling airflow (610) then passes through the space between the burner engaging member (225) and the reflector opening (205). The burner cooling airflow (610) then passes along the burner (140), thereby cooling the burner (140).

The temperature of the burner (140) depends, at least in part, on how much heat is generated by the burner (140) and how much heat is removed due to cooling effects. As introduced, the amount of heat removed from the burner (140) due to cooling effects depends, at least in part, on the volumetric flow rate of the burner cooling airflow (610). Further, as previously introduced, it may be desirable to maintain the burner (140) within a predetermined temperature range, such as between about 850-950 degrees Celsius, or at about 900 degrees Celsius. In order to maintain the burner (140) within such a temperature range, it may be desirable to control the volumetric flow rate of the burner cooling airflow (610).

The volumetric flow rate of the burner cooling airflow (610) may be controlled by varying several dimensions. Some of these dimensions include, without limitation the dimensions of the Z-axis alignment protrusions (300-1, 300-2, 300-3), the dimensions of the Z-axis anti-rotation surface, and the dimensions of the reflector opening (205). For ease of reference, when discussing the dimensions of the Z-axis alignment protrusions and the Z-axis anti-rotation surface, depth shall refer to the dimension of the element parallel to the Z-axis while width will be used to describe the relative dimensions of the elements in the X-Y plane, according to the illustrated coordinate system. The terms deep and shallow will be used to refer to relative depth while wide and narrow will be used to describe width.

Thus, the volumetric flow rate of the burner cooling airflow (610) may be increased to lower the operating temperature of the burner (140) by increasing the space between the base member (220) and the reflector (125). For example, deeper and/or narrower Z-axis alignment protrusions (300-1, 300-2, 300-3; FIG. 3) and/or Z-axis anti-rotation surfaces (310; FIG. 3). In particular, deeper Z-axis alignment protrusions place the base member (220) further from the reflector (125) while narrower Z-axis alignment protrusions provide less obstruction to the burner cooling airflow (610). Further, the volumetric flow rate may be increased by increasing speed of the airflow (600) directed to the reflector (125) by the fan (136).

The volumetric flow rate of the burner cooling airflow (610) may be decreased as well, to thereby increase the operating temperature of the burner (140). For example, shallower and/or wider Z-axis alignment protrusions (300-1, 300-2, 300-3) may be used to decrease the volumetric flow rate. More specifically, a relatively shallower Z-axis alignment protrusion decreases the surface area through which the burner cooling airflow (610) can flow, thereby decreasing volumetric flow rate. Further, a relatively wide Z-axis alignment protrusion provides more obstruction to the burner cooling airflow (610), thereby decreasing the volumetric flow rate of the burner cooling airflow (610). Additionally, the volumetric flow rate may be decreased by decreasing the speed of the airflow (600) directed to the reflector (125) by the fan (136).

Additionally, as shown in FIG. 6, one or more flow obstructers (620) may be coupled to the base member (220). The flow obstructers (620) may be used to cover a portion of the space between the base member (220) and the reflector (125) and thereby reduce the volumetric flow rate of the burner cooling airflow (610). For example, any number of flow obstructers (620) may be used to cover a portion of the space between the base member (220) and the reflector (125) by sliding or otherwise moving them into place. The flow obstructers (620) according to one exemplary embodiment are coupled to the base member (220). Those of skill in the art will appreciate that any number of flow obstructers may be coupled to the base member (220), the reflector (125), or any other suitable location.

Method of Forming a Projection Assembly

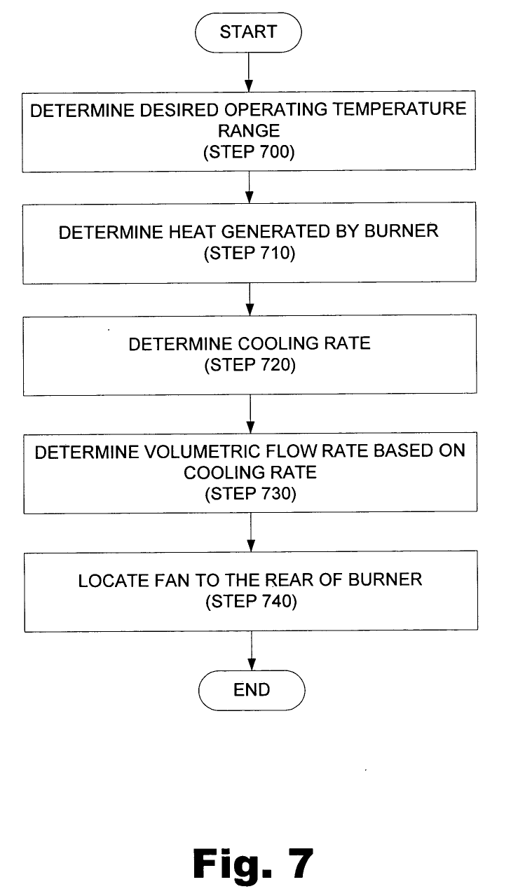

FIG. 7 illustrates a method of forming a lamp assembly. The method begins by determining the desired operating temperature of a burner (step 700). As previously discussed, the operating temperature of a burner according to one exemplary embodiment may be between about 850-950 degrees Celsius. Determining the operating temperature of the burner may include determining the amount of heat associated with the operating temperature of the burner.

The amount of heat generated by the burner is also determined (710). The amount of heat generated by the burner may frequently be greater than the amount of heat associated with the operating temperature of the burner. Accordingly, a cooling rate is determined (step 720). The cooling rate describes the amount of heat to be removed from the burner to maintain the burner within the operating range determined above.

A volumetric flow rate for a burner cooling airflow is then determined based on the cooling rate (step 730). As discussed above, volumetric flow rate may be controlled by varying several factors, including varying the area through which an airflow is passed and varying the speed of the airflow. Once a proper volumetric flow rate is determined, airflow pathways and/or fan settings may be adjusted to achieve the desired volumetric flow rate. According to one exemplary method, these settings may also be adjusted subsequently as desired. A fan may then be located to the rear of the burner (step 740) to provide a cooling airflow to both the reflector and the burner, as will be discussed in more detail below.

Method of Cooling a Projection Assembly

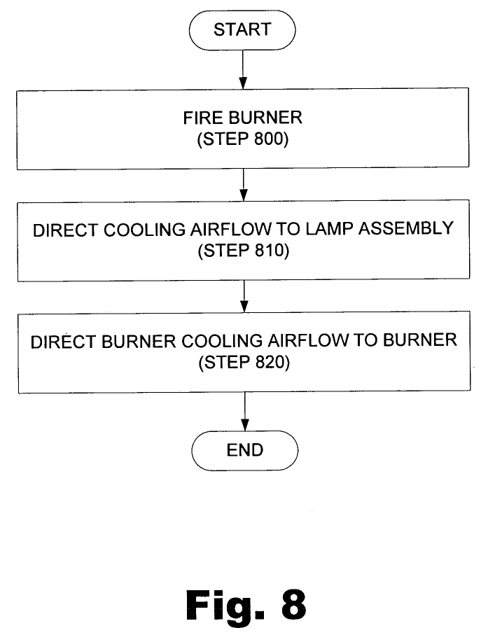

FIG. 8 is a flowchart illustrating a method of cooling a projection assembly. Once a projection assembly is provided, such as according to the method described above with reference to FIG. 7, the burner is fired (step 800). While the burner is hot, a cooling airflow is directed to the lamp assembly from a single fan (step 810).

A substantial portion of the cooling airflow passes over the reflector while a burner cooling portion of the airflow is directed to the burner (820). More specifically, the burner cooling portion of the airflow may flow through air intake holes and along the length of the burner assembly. As the burner cooling portion flows along the length of the burner assembly, the airflow may remain laminar. Accordingly, a single fan may be used to simultaneously cool the reflector and the burner. By using a single fan to simultaneously cool the reflector and the burner, the present method may reduce the noise associated with cooling a burner. Further, such a method may make use of relatively fewer parts, thereby reducing the size of a projector assembly and/or display system that uses such a method to cool a lamp assembly.

In conclusion, an assembly and method have been discussed herein for use in display systems that make use of a lamp assembly. In particular, an exemplary assembly and method have been discussed that make use of a single fan to simultaneously provide cooling for an entire lamp assembly, including simultaneously cooling a reflector and a burner. According to one exemplary embodiment, the fan directs airflow to the lamp assembly. A portion of the airflow passes through spaces between the burner assembly and the reflector and is passed over the burner, thereby cooling the lamp assembly. The amount of heat removed, or the cooling rate, may be controlled by varying several factors, including the volumetric flow rate of the airflow directed to the burner. Such configurations may reduce the noise and space associated with cooling a lamp assembly.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the invention be defined by the following claims.

What is claimed is:

1. A projection assembly, comprising:
a reflector;
a burner coupled to said reflector; and
a fan, said fan being configured to simultaneously cool said burner and said reflector by directing a substantial portion of said airflow over said reflector and a burner cooling portion of said airflow substantially parallel to a long dimension of said burner.

2. The assembly of claim 1, and further comprising a burner header, a datum structure formed on said reflector, and a space defined between said datum structure and said burner header, said space defining an airflow pathway to said burner.

3. The assembly of claim 2, wherein said datum structure includes at least one Z-axis alignment protrusion and said header includes a base member, said base member being configured to be placed into contact with said Z-axis alignment protrusion.

4. The assembly of claim 2, wherein said datum structure includes at least one Z-axis anti-rotation surface.

5. The assembly of claim 2, defining a reflector opening and wherein said burner header includes a burner engaging member, said reflector opening being larger than said reflector opening.

6. The assembly of claim 1, wherein said burner is configured to be removably coupled to said reflector.

7. The assembly of claim 1, wherein said burner comprises an ultra-high pressure mercury bulb.

8. The assembly of claim 1, wherein said reflector comprises a metal.

9. A display system, comprising:
a lamp assembly including a reflector and a burner coupled to said reflector;
a fan, said fan being configured to direct a cooling airflow to said lamp assembly, wherein a substantial portion of said cooling airflow passes over said reflector and a burner cooling portion of said cooling airflow is directed substantially parallel to a long dimension of said burner; and
a spatial light modulator in optical communication with said lamp assembly.

10. The system of claim 9, wherein said lamp assembly is configured to direct air from said fan through at least one gap between said reflector and said burner.

11. The system of claim 10, and further comprising a flow obstructer configured to selectively cover a portion of said at least one gap.

12. The system of claim 10, wherein said lamp assembly includes a header coupled to said burner and a datum structure formed on said reflector, said header being placed into contact with said datum structure, said gap being defined between said header and said datum structure.

13. A method of cooling a lamp assembly, comprising:
directing an airflow from a fan to a lamp assembly, said lamp assembly including a burner and a reflector;
directing a portion of said airflow to said reflector; and
directing a portion of said airflow substantially parallel to a long dimension of said burner.

14. The method of claim 13, wherein directing a portion of said airflow to said reflector includes directing said airflow through a space between a burner header coupled to said burner and a datum structure formed on said reflector.

15. The method of claim 14, and further comprising controlling a volumetric flow rate of said portion of said airflow directed to said burner based on operating conditions of said burner.

16. The method of claim 15, wherein controlling said volumetric flow rate includes controlling said fan.

17. The method of claim 15, wherein controlling said volumetric flow rate includes controlling a size of said space between said burner header and said datum structure.

18. The method of claim 15, wherein controlling said volumetric flow rate includes selectively placing at least one obstruction in said space between said burner header and said datum structure.

19. A method of forming a projection assembly, comprising:
forming a lamp assembly, said lamp assembly include a burner having a long dimension, a reflector, and at least one air intake hole;
providing a fan generally rearward of said lamp assembly, said fan being configured to a direct a cooling airflow to said lamp assembly wherein a substantial portion of said airflow flows over said reflector and a burner cooling portion of said cooling airflow flows through said air intake holes and parallel to said long dimension of said burner.

20. The method of claim 19, and further comprising determining an operating temperature of said burner, determining a volumetric flow rate of said burner cooling portion of said cooling airflow based at least in part on said operating temperature and determining a size of said air intake hole based on said volumetric flow rate.

21. The method of claim 19, wherein forming said lamp assembly includes forming protrusions on said reflector, coupling said burner to a header, and removably coupling said burner to said reflector whereby said protrusions are in contact with said header and said air intake hole is established therebetween.

22. The method of claim 19, wherein forming said lamp assembly includes permanently coupling said burner to said reflector.

23. A display system, comprising:
a lamp assembly including a reflector and a burner coupled to said reflector; and
means for generating a single airflow to simultaneous cool said reflector and said burner, wherein a portion of said airflow flows substantially parallel to a long dimension of said burner.

24. The system of claim 23, and further comprising means for controlling a cooling of said burner.

25. The system of claim 23, wherein said means for controlling said cooling of said burner includes means for controlling a size of a gap between said burner and said reflector.

26. The system of claim 23, wherein said means for controlling said cooling of said burner includes means for controlling a volumetric flow rate of said single airflow.
